(19) United States
(12) Patent Application Publication
(10) Pub. No.: US 2010/0263104 A1
(43) Pub. Date: Oct. 21, 2010

(54) Garment

(76) Inventor: Clodagh Flannery, Athlone (IE)

Correspondence Address: BARNES & THORNBURG LLP, P.O. BOX 2786, CHICAGO, IL, 60690-2786, US

(21) Appl. No.: 12/483,004

(22) Filed: Jun. 11, 2009

(30) Foreign Application Priority Data
Apr. 20, 2009 (GB) GB0906879.2

(51) Int. Cl. A41D 1/00; A41D 27/02; H05B 3/00

(52) U.S. Cl. 2/69; 2/272; 219/211

(57) ABSTRACT

The present invention relates to an improved garment for keeping babies, children and adults warm when in a seated position and more particularly, though not necessarily, to an improved blanket for wearing when in a chair, buggy, wheelchair or the like. It is known to use a blanket to provide warmth to the legs of a wheelchair user. Typically, the blanket is placed upon the thighs; warmth my thereby be retained by the user, albeit be subjected to draughts. However such a blanket is often at least one of bulky, loose, ill fitting, and draughty. Also, it may be dangerous because it may slip off and get caught around the wheelchair wheels, and would be liable to cause an accident. Also, an ordinary blanket often does not provide adequate heat to the user's legs. While parts of the user's legs may be warm there are many gaps allowing any heat that had been retained to be lost. Also when the blanket falls off, all heat will be lost. The present invention seeks to provide, in a general sense, a garment that can securely, repeatedly and conveniently be attached to a seated person, whereby to assist in protecting the person from becoming too cold or too hot. The invention may also be used to protect the wearer in the event that there is some it is raining or from another form of precipitation. According to a first aspect of the present invention there is provided a garment for a seated person, the garment comprising: a first panel configured to fit over the lap of a user, a second panel configured to fit around the lower legs of the user; fastening means operable to enable the second panel to be retained around the legs of the user.

### FIELD OF THE INVENTION

The present invention relates to an improved garment for keeping babies, children and adults warm when in a seated position and more particularly, though not necessarily, to an improved blanket for wearing when in a chair, buggy, wheelchair or the like.

### BACKGROUND

It is known to use a blanket to provide warmth to the legs of a wheelchair user. Typically, the blanket is placed upon the thighs; warmth may thereby be retained by the user, albeit the user will be subject to draughts that may arise. However, such a blanket is often at least one of bulky, loose, ill fitting, and draughty. Also, it may be dangerous because it may slip off and get caught around the wheelchair wheels, and would be liable to cause an accident.

Further, an ordinary blanket often does not provide adequate heat to the user's legs. While parts of the user's legs may be warm there are many gaps allowing any heat that had been retained to be lost. Additionally, in the event that a blanket falls off, all heat will be lost.

When an ordinarily healthy and fit human individual prepares to go outside, for example, to go for a walk, they will tend to dress for the conditions; on a hot sunny day a pair of shorts or a short skirt may be selected; equally when it is cold, a thick pair of trousers or a long skirt or dress is likely to be worn to keep the person sufficiently cool or warm, as the case may be. However, this will not be the case for babies and children in pushchairs and senior members of our society or adults with injury etc. For example, children will have been dressed as appropriate for crawling on the carpet and playing with other children indoors and then they are placed in a buggy or pushchair where their legs are allowed to be cooled, without the circulation due to walking etc to keep their legs warm. Similarly for adults with diabetes, for example, or another ailment whereby they do not possess significant use of their legs and the circulation is poor, their legs will get cold. Indeed, senior members of our society may get cold, whilst watching television when a room that they are in is not sufficiently warm; similar situations whereby the legs of a person (in general, not limited by age, for example) may get cold are numerous, whilst seated at a bus stop, in a car etc. Equally children may not realise to move their legs when it is summer and it is too hot: the legs of a child could get too hot whilst in a push chair or buggy—similar conditions can occur with adults in a wheelchair, when they cannot move their legs to a sufficient degree to avoid discomfort through heat.

DE 102005006108 (I Hoffmann) provides a device is assembled of an upper part to be positioned on top of and partly wrapped around the abdomen and the thighs of the user, a lower part to be wrapped around the lower legs and a segment to be folded around the feet. The lower part can be specifically shaped for a person with only one leg or with one of the legs not capable to bend. A pocket on the upper part can be used for the accommodation of the blanket when not in use. There could also be two pockets to be used as a hand-warming muff. A waterproof version of this is provided in DE10331165. DE19858288 teaches to a further variation and provides a wheelchair blanket, which is cut like an apron at the top and is stitched in at the knee area for a better fit. A lateral extension of the blanket can be wrapped around the legs. The top straps and the lateral extension can be joined to the cover of the wheelchair with strips of a hook and loop fastener. The blanket can be made of a waterproof or an insulating material which could additionally be fitted with a soft lining.

US20050097671 provides a blanket having a lower portion shaped like a pillow-case, whereby a pouch is formed. This blanket is designed for children; the blanket is attached once the child is seated in a buggy or pushchair and removal is necessary before the child can stand up (if capable). Furthermore, the upper portion is designed to envelope the child's thighs and fasteners are provided to attach the blanket ends together, the width of the upper portion being typically at least twice as wide as the lower portion; in use the child is lifted so that the blanket is fastened to the rear of the child, which could prove to be uncomfortable and is likely to interfere with the operation of a harness that will necessarily be required to maintain the child upon the buggy or pushchair. Draughts are not prevented from affecting the user when seated since the top of the pillow-pouch is not fastened to the legs

### OBJECT TO THE INVENTION

The present invention seeks to overcome or ameliorate at least some of the disadvantages described above. The present invention seeks to provide a garment suitable, in particular, for reliable use by children and babies in pushchairs and buggies and injured or frail adults, whereby to keep warm in cold conditions and cool in hot conditions, when normal circulation of blood within the leg is absent. The present invention also seeks to provide a secure blanket to keep a person's legs warm and/or dry.

The present invention seeks to provide, in a general sense, a garment that can securely, repeatedly and conveniently be attached to a seated person, whereby to assist in protecting the person from becoming too cold or too hot.

### SUMMARY OF THE INVENTION

According to a first aspect of the present invention there is provided a garment for a seated person, the garment comprising: a first panel configured to fit over the lap of a user, a second panel configured to fit around the lower legs of the user; fastening means operable to enable the second panel to be retained around the legs of the user.

In one embodiment, the garment comprises gussets on each side, secured between the first and second panels. These gussets provide the advantage of eliminating draughts that may otherwise occur, since the gussets extend, at least in part, in the region between the inside leg of a user and the seat upon which the user will be seated at.

The garment can be manufactured from a variety of materials, including, but not limited to polyester fleece, wool, tweed, waterproof materials in whole or in part. Conveniently, the panels are generally rectangular in shape.

The fastening means may comprise of first and second strips of hook and loop fasteners; conveniently, at least one strip on a front side of the second panel is substantially perpendicularly to at least one strip on the rear side of the second panel. Equally, the fasteners may comprise corresponding first and second releasable zip fasteners, buttons or other types of material fasteners.

Conveniently the first and second panels are manufactured from a single piece of fabric. The gussets may be fastened on as separate pieces of material or may be formed by constructing a middle section between two gusset in an accordion pleat, the middle section being defined in the area of the garment between the first and second panels.

Conveniently, there is also provided a third panel, which can be closed at one end, especially for toddlers in pushchairs, whereby the feet of the user may also be kept warm and/or dry. Again, hook and loop fasteners can be fitted to corresponding second and third panels. If employed as a waterproof cover for the feet the third portion can be attached either to an inside face of the arrangement when in use. In the alternative, the third panel is attached by attachment means such as hook and loop fasteners to a lower outside surface of the second panel, conveniently below a lip defined in the outer portion of the second material, whereby rain, for example, running down an outside surface of the second panel passes over the lip and onto the outside surface of the third, lowermost panel. Whilst providing some protection from the wind, this feature will prevent water passing from the outside of the second panel into the areas otherwise protected by the third panel, with the likelihood of causing the feet to be soaked.

In the manufacture of the garment, different sizes can be made, to accommodate differences in the sizes of users of the invention. Whilst many patterns may be available to suit the user (or their parent) for scooter users, a high visibility colour may be considered; retro-reflective panels can be utilised.

### BRIEF DESCRIPTION OF THE DRAWINGS

Reference shall now be made to the Figures a shown in the accompanying drawing sheets, wherein:

FIG. 1 illustrates a front view of a first embodiment of the invention;

FIG. 2 details a gusset in accordance with a preferred embodiment;

FIG. 3 details a rear view of the first embodiment of the invention;

FIGS. 4a-4d illustrate how the device may be attached around a seated person;

FIGS. 5a and 5b show another aspect of the invention;

FIG. 6 show a toddler seated in a pushchair;

FIG. 7 shows the use of the invention by a scooterist;

FIG. 8 shows a fisherwoman wearing a garment in accordance with the invention;

### DETAILED DESCRIPTION OF THE PREFERRED EMBODIMENTS

There will now be described, by way of example only, the best mode contemplated by the inventor for carrying out the present invention. In the following description, numerous specific details are set out in order to provide a complete understanding to the present invention. It will be apparent to those skilled in the art, that the present invention may be put into practice with variations of the specific.

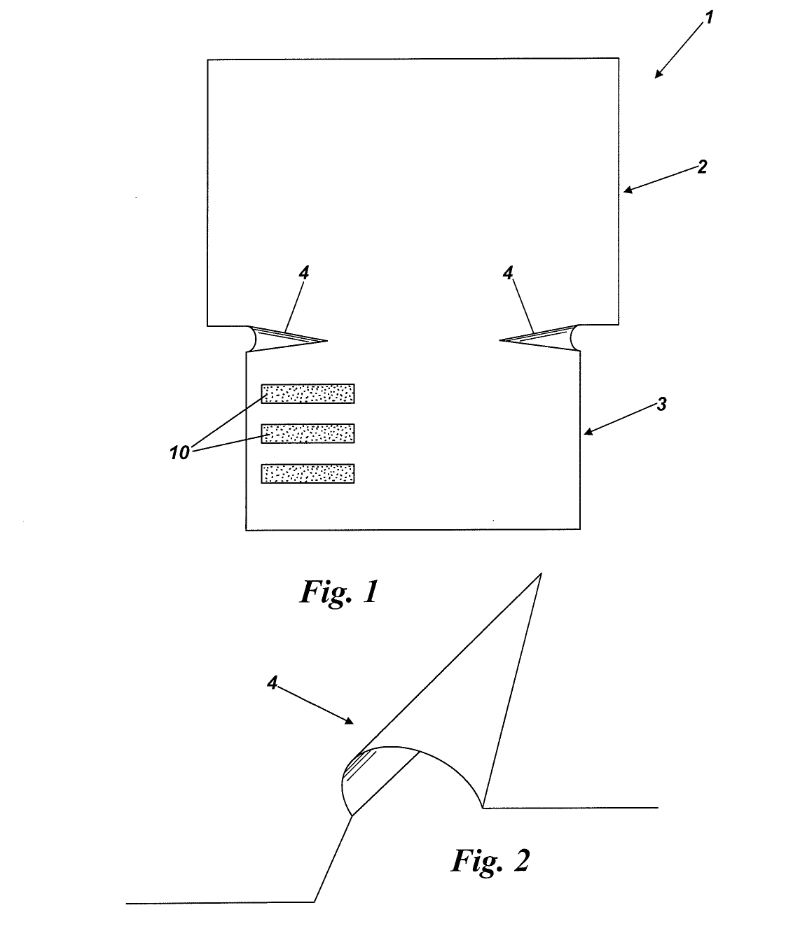

FIG. 1 shows a font view of a garment 1 comprising a first section 2 of general rectangular configuration which is joined to a smaller generally rectangular portion 3: gussets 4 are provided at the edges of a line dividing the first and second sections. Conveniently the first and second sections are made from a single piece of material (which may comprise several layers: for example, a breathable waterproof membrane may lie on the outside a pocketed thicker material on the inside with a soft combed material on an inside face; alternatively the material may comprise but a single layer, for example a polyester fleece material). Reference numeral 10 refers to loop-sections of hook and loop fasteners. With reference to FIG. 2, the gusset portions 4 are detailed and can be sewn onto the garment as separate pieces of material. In the alternative, the gussets comprise non-interleaved sections of material, the interleaving being defined by stitching such that there are accordion pleats formed, which conveniently allows the material in the middle to stretch, if desired, whereby to enable a snug, draft-free fit to be provided when in use. The top panel 2 is shaped for fitting over and around the users lap, whereas the lower panel 3 is shaped for fitting around the user's lower legs. The gussets 4 are shaped to fit behind the user's knees. The garment 1 is used by placing the top panel 2 on the user's lap and tucking in down gently at the edges or merely placing on top, as is the case, in particular, with children in a stroller pushchair. The lower panel is wrapped around the lower legs so that it comfortably surrounds the lower legs. The arrangement of the fastener strips 10 and 11 allows a wide variation in circumference; when using the garment as described, the gussets automatically find a perfect fit behind the user's knees.

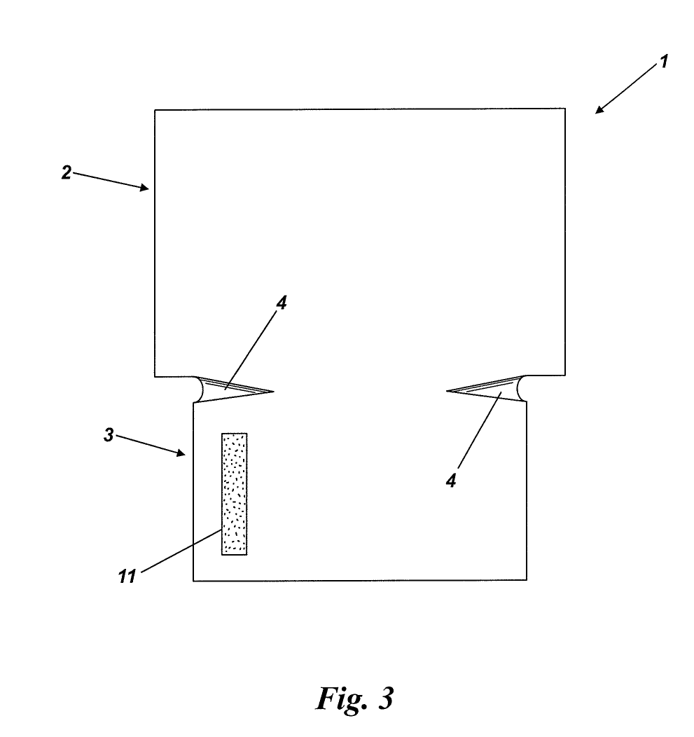

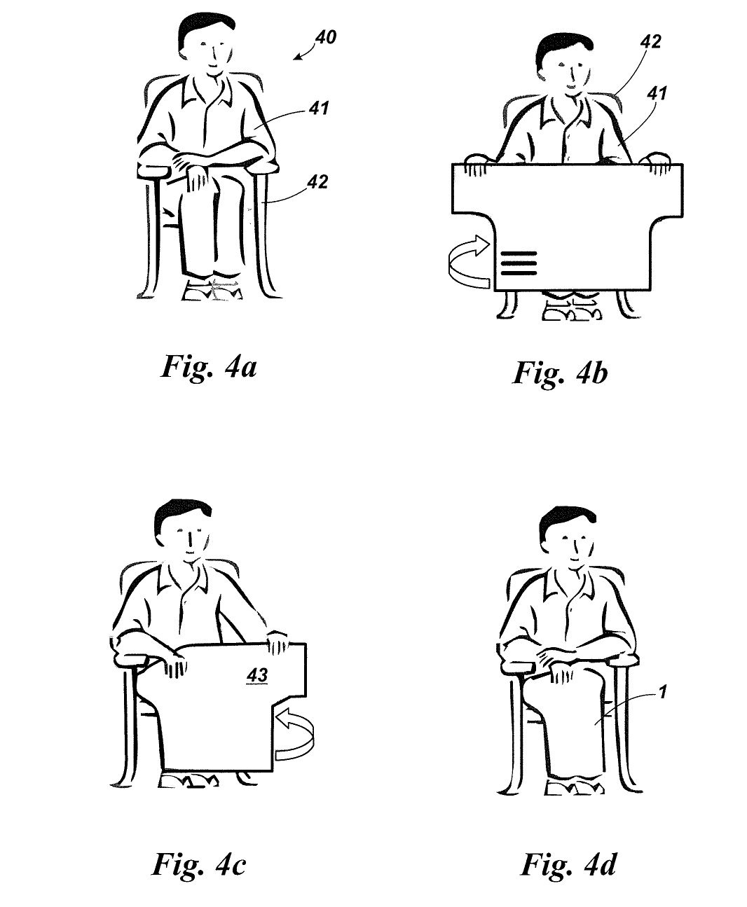

FIG. 3 shows a reverse side of the garment, which has a single hook-strip-section of a hook and loop fastener arrangement, arranged at right angles to the loop-strip-section of the front face of the garment. Use of the garment shall now be described with reference to FIGS. 4a-4c. Initially referring to FIG. 4a, there is shown at 40 a man 41 sitting in a chair 42; in FIG. 4b, the man holds the top edge of the first panel and allows the garment to hang, with the front face 43 facing away form the body of the man; the right hand side of the garment is then, at the top, tucked under the right buttock and thigh of the man, with the lower, second panel being directed around toward the rear of the lower legs of the man. In FIG. 4c, the corresponding tucking in of the garment for the left hand side is performed, with the lower left section being attached, by way of the hook members of the hook and loop fasteners of the inside face attaching to the corresponding loop fastener elements arranged on an outside surface of the lower panel, whereby to achieve a good, draught-free fit of the garment with the user to the chair, as shown in FIG. 4d. Note, however, the fitment to a chair may differ with respect to a buggy; a child in a push-chair of the folding variety may well have the garment attached around the legs of the child; the upper part of the garment being placed upon the lap of the child; the arms conveniently remaining above the garment, although in particularly cold conditions, the lower arms may be placed underneath the garment. It may be preferred, however, that the upper part of the blanket, either for the adult of child version, that it is merely laid upon the lap.

The gussets provide a significant improvement to the two panel construction in that they enable the garment to naturally fold about the knee and provide a draught-free fit, since the corresponding upper and lower panel fit is not compromised by a lack of material at the fold, combined with the different means of attaching the lower panel with respect to the upper panel. In use, the garment remains in position and retains an insulating layer of heat around the user's legs. This is achieved by the tailored cut of the blanket, the positioning of the closing mechanism and the tailor-made gussets. A further significant advantage is that the garment will not fall off or get caught around the user's wheels. For example, when properly fastened around a child's legs, the child will still be free to move their legs, even in a kicking fashion, despite that fastening

It will be appreciated that the garment in accordance with the invention actually helps in the generation and retention of heat. It does this by snugly fitting and excluding any draughts, especially at the back of the user's knees. This area behind the knees naturally generates heat as the upper and lower parts of the legs are in very close proximity to each other when a person is in a sitting position. If skin is subject to a draught of air that is cool, then vaso-constriction will occur, making the skin colder, due to a reduction in the flow of blood in the region of the draught. Accordingly, in an absence of a draught, then the skin shall become warmer. In the alternative, the garment could be made from a thin sheet-like plastics waterproof material and offer more protection from precipitation, although air would still be capable of being trapped, whereby heat may be retained by a wearer of the garment, even though its primary use was to provide waterproofing.

When the garment warms up, due to the trapped air, heat and contact with the body will warm up the user's legs at the back of the knees and heat up the blood in this area which will be naturally circulated to all parts of the legs and the body. It will be appreciated that by the use of hook and loop fasteners, a large variety of shapes and sizes of user can be accommodated. The hook and loop fasteners retain the garment in close proximity to the legs of the user; this assists in allowing the garment to remain where it is placed in a comfortable manner. Of course, there are other types of fasteners which will offer the same and other advantages. The garment can be manufactured in a range of sizes. Equally, the garment can be tailored and made from materials such that a user, for example a wheelchair user does not get too hot in the summer, when outside in the sun, particularly on humid days—it is of advantage that the material be of lightweight and of a light colour, whereby to absorb less heat, as is known.

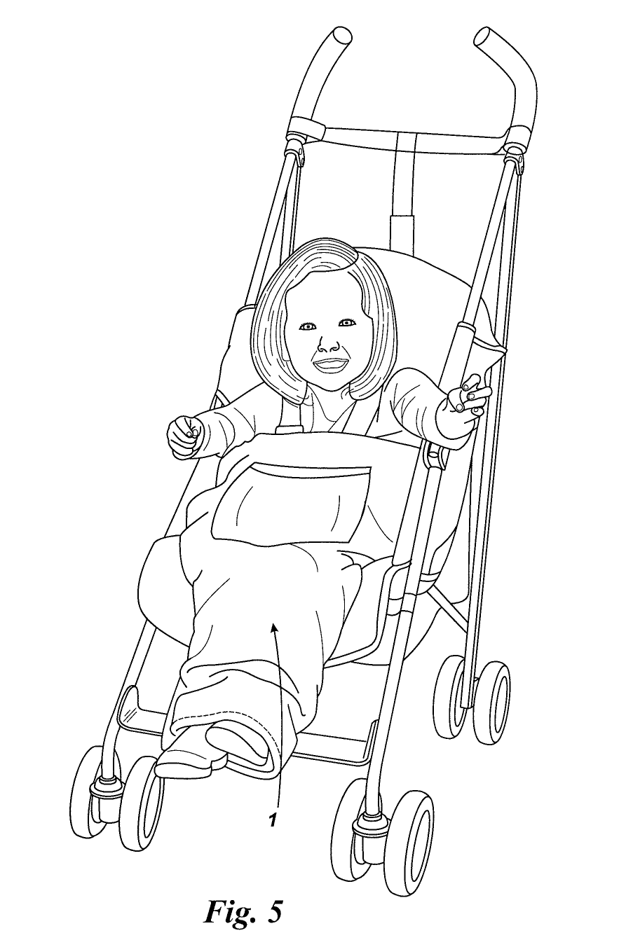

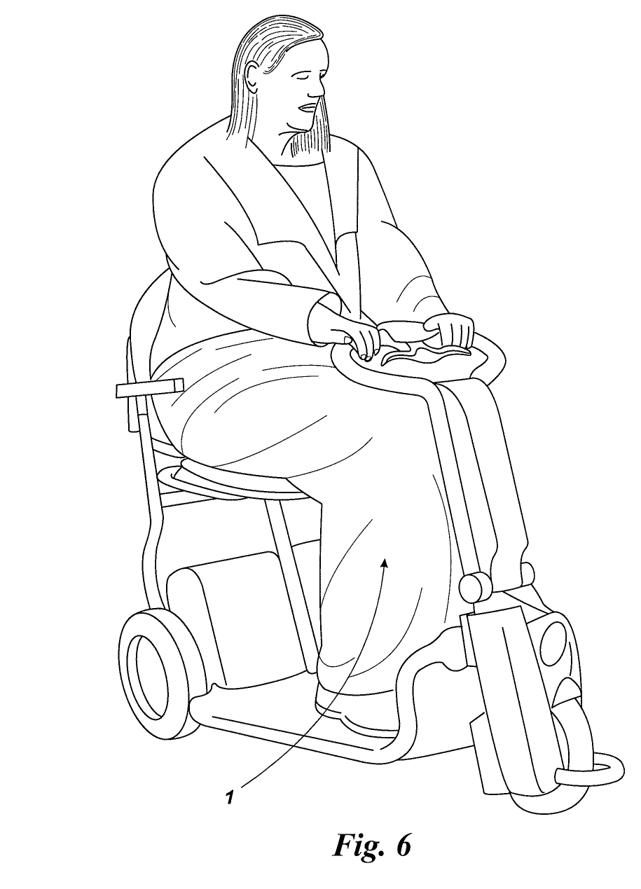

FIG. 5a shows a further embodiment of the invention, wherein a third panel, 52 is attached to a lower portion of the second panel. A lip member 57 is shown in this embodiment; which overlaps the third panel, which can either be arranged as a pouch-like member or, as is shown here, a panel which can be folded around the feet and ankles of the user. The inside surface 58 is shown in an unfolded state in FIG. 5b, a fastener such as a hook an loop fastener strip 55 is shown, which attaches to the outside of the second panel, below the lip 57. The specific positioning of the lip is not significant, the position could be dependent upon the artistic look and feel of the design feature, although a skilled person would know that sufficient overlap must be provided to enable the third panel to be effective in preventing ingress of moisture about the foot of the wearer, if designed to be waterproof. Once attached to the front, the third panel has the right hand side folded around to the foot to allow hook and loop members indicated (but not shown) by arrow 53 to be exposed and, upon bringing the left hand panel to the rear, allow connection with corresponding hook and loop fastener indicated at 54. Other fasteners can be used. The material can be waterproof; the material may be more rugged, as users may well stand upon the panel if they put their feet down before taking off the garment.

The present invention will be appreciated by users of wheelchairs users, scooters and fishermen who will appreciate a waterproof and heat regulating garment. Accordingly, in a further embodiment of the invention, the garment may have a detachable waterproof sheet or layer that can be attached to a fabric under layer employed for heat regulation. Equally the garment my have a permanent waterproof membrane, such as is marketed under the Goretex® brand.

The invention is not limited to the embodiments described but may be varied in construction and detail. For example, the garment may have further features such as a hand warming pocket which could be used in a similar fashion to a mitten, the pocket could be used for other purposes, such as keeping of toys—in the case of children or wallets, mobile phones, spectacles etc. for adults. A pocket may also be arranged to retain a third panel or foot pocket. An inside pocket, accessible only form the inside when worn is preferably provided for keys, mobile phones, wallets etc. One pocket may be adapted to retain a battery; in conjunction with leads and a switch, the system may be adapted to power electrical heating cells placed within the garment. The heater cells may be sewn into the material or may be placed in pockets; as such they can be removed for cleaning. Heating elements can be powered by small batteries such as lithium-ion batteries or similar and provide sufficient heating for half an hour or longer, dependant upon temperature increase required and the areas of the blanket being heated. A typical unit can comprise, say, a 4400 mAh Lithium-Ion battery and such an electrical battery can provide sufficient electrical energy to heat a basic circuit with several pairs of heating elements on a maximum heat setting for 7 hours or so. It is envisaged that various battery options can be utilised. The blanket, as described above is conveniently arranged such that one circuit can provide a background level of heating over all the surface area of the blanket, with the although it may be desired to heat up just the lower legs and/or the knees.

Whilst many types of electrical heating arrangements can be employed, it is preferred that non-metallic systems are employed; typical polyester film heating systems can be cleaned in suitably sized washing machines, without any particular dry-cleaning process being employed; certainly, ferrous heaters would oxidise quickly and could not be incorporated into a blanket permanently. Non-metallic carbon polyester based heater elements are strong flexible and waterproof. Polyester film heaters are comprised of thin layers of varying materials bonded to form heater laminates. The electro-thermal conductive inner layer comprise a coated silver and carbon based paste and is typically laminated between a heat conducting outer layer, and an insulating layer that seals and protects. It is preferred that the outer layer materials exhibit good thermal conductivity, while being essentially electrical non-conducting; polyester film heaters provide these characteristics.

As will be appreciated, for a young child, the garment can have several pockets and or devices attached to the garment such as: ‘Toy gripping tassles’ i.e. Fancy strings to be used to tie onto toys in order to prevent them falling on ground; Learning features—e.g. cloth books etc. The garment may be provided with a matching hat and scarf set. The present invention will thereby provide a warm, secure, fun environment for a child.

A particularly notable advantage of the present invention is that the garment—suitably sized—can be effectively employed by all manner of folk, once seated. For example, when one is watching a football, rugby or other sport in a stadium, particularly during the evening of a winter's day; the garment can be used by other pastimes where one is seated for extended periods of time such as fishermen. The garment can also be used by disabled and/or infirm users of mobility scooters. Whilst a football stadium may well be equipped with a roof, it may still be cold when one is seated during a soccer of rugby match; up to two hours on a cold day or night may well precede the onset of a cold; the present invention will make a afternoon or day in the stands that much more enjoyable. A variation of the invention also includes side arms of the first panel being sufficient in width to be sat upon, whereby to ensure that warmth is retained; ideally the lowermost portion is impermeable to water, whereby on may sit upon a seat at a football or rugby ground, even when the seat is wet. The garment may conveniently be provided with an integral pocket-bag whereby the garment can be folded into such a pocket; a loop or straps may be fitted to assist with picking up and holding onto the garment.

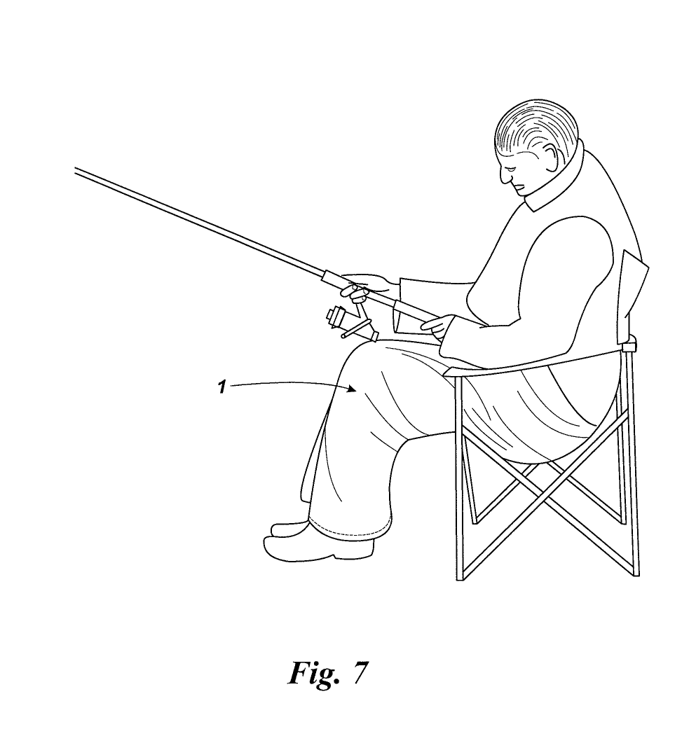

With reference to FIG. 6, a toddler is shown seated in a pushchair. It can be seen that the child is snugly wrapped up; the presence of drafts being eliminated by the use of the first and second panels joined together with the use of a gusset to eliminate the possibility of drafts between the user and the seat. It will be appreciated FIG. 7 shows the use of the invention by a scooterist; FIG. 8 shows a fisherwoman being kept warm with the present invention. Indeed, the present invention can be used, indoors, whereby to enable a cooler house not to affect the health of those inside, who, when not walking around or otherwise generating heat, can watch a television, work in front of a computer without the temperature of the room being higher than necessary. Equally, passengers of cars may wish to keep warm; senior members of our society along with toddlers and small children in car safety seats.

It has been found that a range of four sizes can comfortably accommodate most folk, although such common dimensions are not to be seen as a limitation. For example, it has been found that for a toddler a width of the first and second panel can be 85 cm and 73 cm respectively, the height being 53 cm and 30 cm, respectively. In the case of a junior application, then corresponding widths of 97 cm and 84 cm have been found to be appropriate, with corresponding heights of 59 cm and 37 cm. The widths of a first adult version can be 106 cm and 95 cm, with the corresponding heights of 67 cm and 45 cm; the second adult version being 121 cm and 109 cm, with heights of 72 cm and 49 cm, being suitable for a large adult. The gussets are typically dimensioned to be 14-20 cm in width, with an amount of material extending approximately 8-10 cm to extend between first and second panels. These dimensions will vary, according to taste, purpose and overall garment size.

It will be appreciated by the person of skill in the art that various modifications may be made to the above described embodiments without departing from the scope of the present invention.

1. Apparatus comprising a garment for a seated user, the garment comprising:
A first panel, configured to fit over the lap of a user;
A second panel configured to fit around the lower legs of a user;
fastening means for retaining the second portion about the lower legs of a user.

2. A garment as claimed in claim 1, wherein the garment comprises a gusset on each side between the first and second panels.

3. A garment as claimed in claim 1, wherein the fastening means comprises strips of hook-and-loop fasteners, in which at least one strip on a front side of the lower panel is substantially perpendicularly to at least one strip on the rear side of the lower panel.

4. A garment according to claim 1, wherein the second panel has a smaller width dimension than the first panel.

5. A garment according to claim 1, wherein there is a provided a second layer to the garment, being an outer waterproof material.

6. A garment according to claim 1, wherein there is further provided a lining material.

7. A garment according to claim 1 wherein there is further provided a third portion of material configured to be retained above the foot of the user, operable to maintain temperature of the feet of the user.

8. A garment according to claim 1 wherein there is further provided a third panel of material configured to be retained above and around the foot of the user, operable to maintain temperature of the feet of the user, the third portion being releasably attached to one of the inside or outside of the second panel.

9. A garment according to claim 1 wherein there is provided one or more electrical heater elements with in the garment.
